(19) United States
(12) Patent Application Publication
(10) Pub. No.: US 2023/0289680 A1
(43) Pub. Date: Sep. 14, 2023

(54) PREDICTING AND INDEXING INFRASTRUCTURE PROJECT REQUIREMENTS

(71) Applicant: ADP, Inc., Roseland, NJ (US)

(72) Inventors: Ramsay COLE, Roxbury, CT (US); Gil GERSTL, Cresskill, NJ (US)

(21) Appl. No.: 17/690,527

(22) Filed: Mar. 9, 2022

(51) Int. Cl. G06Q 10/06; G06Q 10/10

(52) U.S. Cl. CPC G06Q 10/06313; G06Q 10/1053

(57) ABSTRACT

The present disclosure relates generally to managing infrastructure projects and, more particularly, to a computer-implemented method and system of indexing and predicting infrastructure project requirements. A computer-implemented method includes: aggregating, by a computer system, employment data; analyzing, by the computer system, the employment data to generate predicted infrastructure projects; and indexing, by the computer system, each of the predicted infrastructure projects for different geographic regions.

### TECHNICAL FIELD

The present disclosure relates generally to managing infrastructure projects and, more particularly, to a computer-implemented method and system of indexing and predicting infrastructure project requirements.

### BACKGROUND

Gathering and analyzing multiple infrastructure project requirements, e.g., municipality to municipality, is challenging using traditional sources of data and tools. For example, it is possible to monitor infrastructure of a single municipality for repairs and maintenance, but no information or tool is available to compare and prioritize municipality needs against one another. In other words, leveraged data is locally applied rather than used to prioritize the needs between different regions. Further, traditional methods of monitoring infrastructure do not account for many factors that may affect the infrastructure.

Traditional data collection may use census data; however, this data can become very stale and does not account for population changes between each census collection year. This data also does not account for other changes related to population changes, e.g., need for increase network capacity, etc. In other words, current tools, at most leverage a static/point in time, which may result in a delayed or misinterpreted understanding of current infrastructure needs, and does not consider future requirements and needs of geographic regions. For example, this data does not take into account more recent changes in demographics which may affect infrastructure projects. These changes may include, e.g., teleworking which may overburden telecommunication networks, migration shifts away from more costly urban environments, etc.

### SUMMARY

In a first aspect of the present disclosure, a computer-implemented method comprises: aggregating, by a computer system, employment data; analyzing, by the computer system, the employment data to generate predicted infrastructure projects; and indexing, by the computer system, each of the predicted infrastructure projects for different geographic regions.

In another aspect of the present disclosure, there is a computer program product for indexing and predicting infrastructure project requirements. The computer program product includes one or more computer readable storage media having program instructions collectively stored on the one or more computer readable storage media. The program instructions are executable to obtain payroll data; obtain infrastructure data; analyze the payroll data and the infrastructure data to determine future infrastructure needs; index predicted infrastructure projects associated with the future infrastructure needs for different geographic regions based on at least the future infrastructure needs and the obtained payroll data; and prioritize recommendations for the predicted infrastructure projects based on the obtained payroll data and the infrastructure data.

In a further aspect of the present disclosure, there is a computer system for indexing and predicting infrastructure project requirements. The system includes a processor, a computer readable memory, one or more computer readable storage media, and program instructions collectively stored on the one or more computer readable storage media. The program instructions are executable to collect employment data; collect infrastructure data; analyze the employment data and the infrastructure data to generate predicted infrastructure projects, including: determine future infrastructure needs including project-by-project requirements for the predicted infrastructure projects, and determine an infrastructure project value for a project timeline of a geographic region based on the future infrastructure needs, the infrastructure project value being a percentage of an aggregation of the future infrastructure needs of all the predicted infrastructure projects of the geographic region; and index each of the predicted infrastructure projects for the geographic region based on the infrastructure project value of each of the predicted infrastructure projects of the geographic region.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 is an illustrative architecture of a computing system implemented in embodiments of the present disclosure.

FIG. 2 shows an exemplary cloud computing environment in accordance with aspects of the present disclosure.

FIG. 3 shows a block diagram of an infrastructure project device in accordance with aspects of the present disclosure.

FIG. 4 depicts an exemplary flow for a process in accordance with aspects of the present disclosure.

### DETAILED DESCRIPTION OF ASPECTS OF THE INVENTION

The present disclosure relates generally to managing infrastructure projects and, more particularly, to a computer-implemented method and system of indexing and predicting infrastructure project requirements. More specifically, the present disclosure provides methods and systems for predicting and prioritizing infrastructure projects in different geographic regions based on at least payroll information, e.g., employment data which includes location of employment, address of employer, type of work, amongst other factors. These infrastructure projects may include, amongst others, building or updating roads, bridges, telecommunication networks, waste management capacity, etc. Advantageously, by using payroll data, infrastructure projects can be predicted for different geographic regions and such projects can be prioritized based on current and projected future needs of a particular community or region using real time dynamic data sets.

In more specific embodiments, the disclosure relates to an improved computer system and, more specifically, to a method, apparatus, system, and computer program product (also generally referred to as “tools”) configured to address current and future infrastructure planning challenges. The tools provided herein may aggregate sample data regarding a plurality of factors associated with employment and geographic region, perform iterative analysis on the sample data using machine learning to construct a predictive model, populate, using the predictive model, a database with predicted values of infrastructure project requirements for a selected set of predefined geographic regions and convert the predicted values of infrastructure project resource requirements (project by project). The values may be in the form of percentages of observed values of infrastructure requirements for geographic regions within the selected set over a specified time-period. This data may also be layered with other data as disclosed herein to predict and prioritize infrastructure projects.

In this way, it is possible to create indices of infrastructure project resource requirements and rank orders of importance of the projects according to geographic regions within the selected set according to their indices of infrastructure project needs (project by project). That is, by implementing the tools provided herein, it is now possible to rank and prioritize infrastructure projects using, in the least, payroll data, which provides current, real time data sets to provide enhanced infrastructure planning solutions. This will allow governments to efficiently build infrastructure such as, providing new roads, water pipes, etc., as well as repairing older roads, water pipes deployed once the hazardous lead pipes have been removed, provide broadband connectivity, etc.

In implementation, in addition to payroll data, data sets such as building footprint data, broadband connectivity data, existing water pipe blueprint data, commodity shipping data, etc., can be leveraged to show where problems exist in the infrastructure and help in the planning process. When these data sets are layered with trending payroll and demographic data by geography, the solution becomes intelligent and can identify which regions need immediate or future assistance based on a comparison to other regions. In this way, these data sets can be leveraged to create models that rank and score the current as well as future predicted needs, project by project of each municipality across the country. In addition, utilizing such data sets allows intentional planning, providing communities with the required resourcing and infrastructure to access economic opportunities.

Accordingly, the tools described herein provide a technical solution to a problem by addressing current infrastructure needs across different geographic regions. Generally, this technical solution can be accomplished by, amongst other features as described herein, machine learning techniques, with models that learn over time. For example, implementations utilize infrastructure project modelling such as using machine learning and/or neural network computing to predict infrastructure project requirements and based on these requirements determine an indexing and/or priority of the infrastructure projects. The machine learning techniques can index and predict infrastructure project requirements including aggregating sample data regarding a plurality of factors associated with employment and geographic region. And by aggregating the infrastructure data, it is possible to generate a clear picture of all the factors that affect the prioritization of infrastructure projects and predict what is needed to maintain and/or improve infrastructure. Thus, implementations of the invention provide an improvement in the technical field of infrastructure project management by providing a technical solution to the problem of determining infrastructure project indexing and predicting.

Implementations of the present disclosure may be a computer system, a computer-implemented method, and/or a computer program product. The computer program product may include a computer readable storage medium (or media) having computer readable program instructions thereon for causing a processor to carry out aspects of the present disclosure.

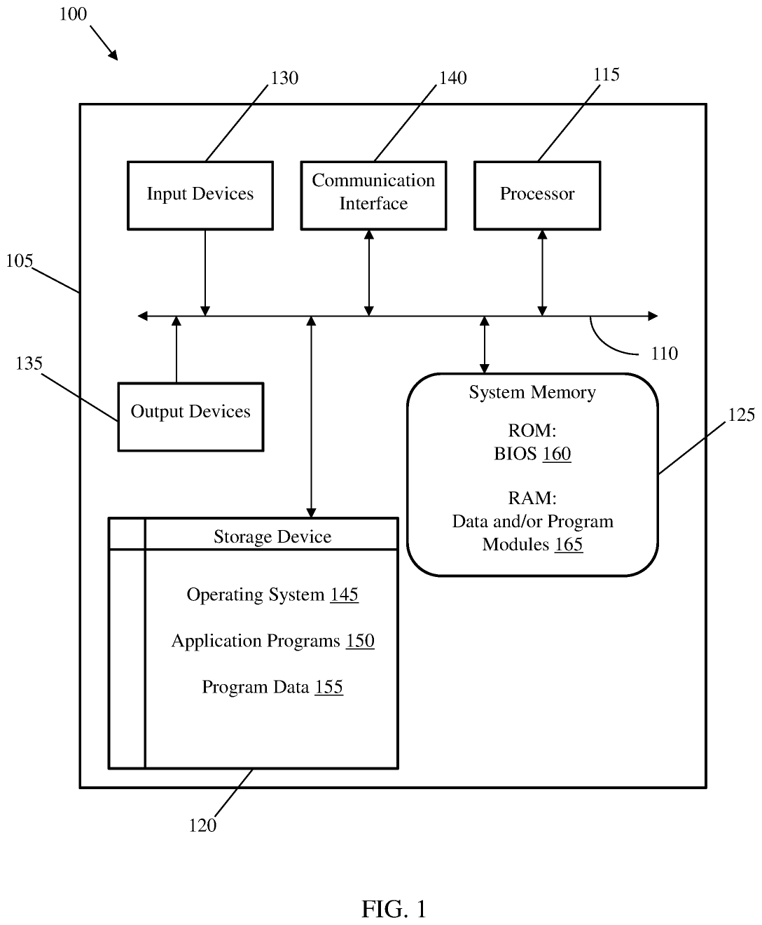

FIG. 1 is an illustrative architecture of a computing system 100 implemented in embodiments of the present disclosure. The computing system 100 is only one example of a suitable computing system and is not intended to suggest any limitation as to the scope of use or functionality of the disclosure. Also, computing system 100 should not be interpreted as having any dependency or requirement relating to any one or combination of components illustrated in computing system 100.

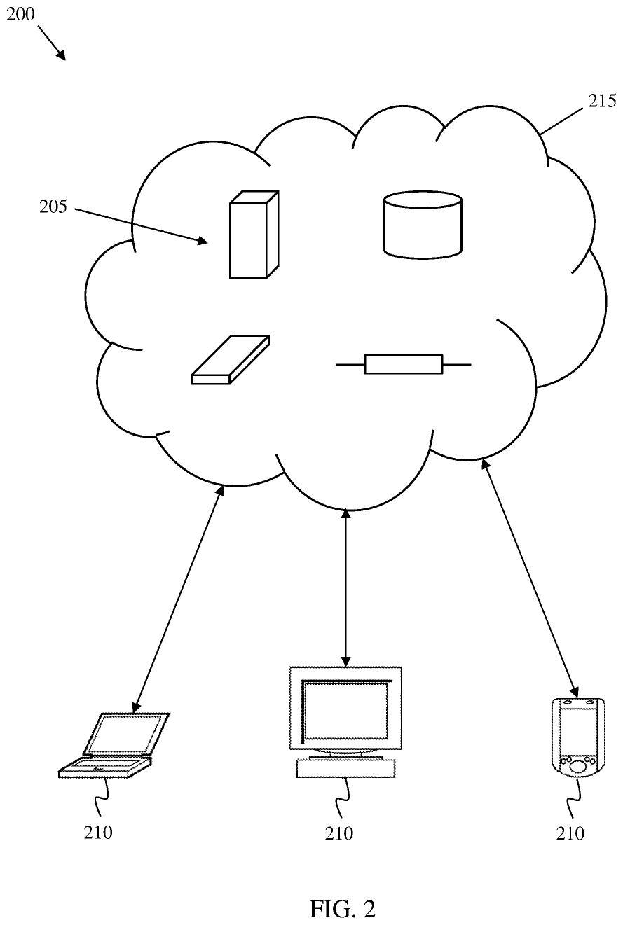

As shown in FIG. 1, computing system 100 includes a computing device 105. The computing device 105 can be resident on a network infrastructure such as within a cloud environment as shown in FIG. 2, or may be a separate independent computing device (e.g., a computing device of a third-party service provider). The computing device 105 may include a bus 110, a processor 115, a storage device 120, a system memory (hardware device) 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more processors or microprocessors that include any processing circuitry operative to interpret and execute computer readable program instructions, such as program instructions for controlling the operation and performance of one or more of the various other components of computing device 105. In embodiments, processor 115 interprets and executes the processes, steps, functions, and/or operations of the present disclosure, which may be operatively implemented by the computer readable program instructions.

For example, processor 115 enables the computing device 105 to index and predict infrastructure project requirements using real-time information such as payroll data, optionally in conjunction with other static type of data such as data obtained from municipalities including current conditions and needs for roads, mass transit, e.g., airports, trains, etc., water supply, waste and water management, power generation and transmission, telecommunication networks and hazardous waste removal storage. The process 115 can also prioritize which infrastructure needs are to be completed, and prioritize these projects based on, for example, population migrations, employee needs, etc.

In embodiments, processor 115 may receive input signals from one or more input devices 130 and/or drive output signals through one or more output devices 135. The input devices 130 may be, for example, a keyboard, touch sensitive user interface (UI), etc., as is known to those of skill in the art such that no further description is required for a complete understanding of the present disclosure. The output devices 135 can be, for example, any display device, printer, etc., as is known to those of skill in the art such that no further description is required for a complete understanding of the present disclosure.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present disclosure. In embodiments, storage device 120 may store operating system 145, application programs 150, and program data 155 in accordance with aspects of the present disclosure.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 may be configured to aggregate infrastructure data and predict and prioritize needs for infrastructure projects on a project-by-project basis, amongst a plurality of geographic locations. In particular, computing device 105 may perform tasks (e.g., process, steps, methods and/or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In embodiments, an operator may interact with computing device 105 via the one or more input devices 130 and/or the one or more output devices 135 to facilitate performance of the tasks and/or realize the end results of such tasks in accordance with aspects of the present disclosure. In additional or alternative embodiments, hardwired circuitry may be used in place of or in combination with the program instructions to implement the tasks, e.g., steps, methods and/or functionality, consistent with the different aspects of the present disclosure. Thus, the steps, methods and/or functionality disclosed herein can be implemented in any combination of hardware circuitry and software.

FIG. 2 shows an exemplary cloud computing environment 200 in accordance with aspects of the disclosure. Cloud computing is a computing model that enables convenient, on-demand network access to a shared pool of configurable computing resources, e.g., networks, servers, processing, storage, applications, and services, that can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to client devices 210 via a network 215, such as the Internet. Cloud resources 205 can include a variety of hardware and/or software computing resources, such as servers, databases, storage, networks, applications, and platforms. Cloud resources 205 may be on a single network or a distributed network. Cloud resources 205 may be distributed across multiple cloud computing systems and/or individual network enabled computing devices. Client devices 210 may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a client does not need to maintain resources on a local client device 210. In embodiments, cloud resources 205 may include one or more computing system 100 of FIG. 1 that is specifically adapted to perform one or more of the functions and/or processes described herein.

Cloud computing environment 200 may be configured such that cloud resources 205 provide computing resources to client devices 210 through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210. For example, cloud resources 205 can provide SaaS to a first client device 210 and PaaS to a second client device 210.

Cloud computing environment 200 may be configured such that cloud resources 205 provide computing resources to client devices 210 through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

In embodiments, software and/or hardware that performs one or more of the aspects, functions and/or processes described herein may be accessed and/or utilized by a client (e.g., an enterprise or an end user) as one or more of a SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via a client device 210 in communication with cloud resources 205. The UI can be configured to operate in a variety of client modes, including a fat client mode, a thin client mode, or a hybrid client mode, depending on the storage and processing capabilities of cloud resources 205 and/or client device 210. Therefore, a UI can be implemented as a standalone application operating at the client device in some embodiments. In other embodiments, a web browser-based portal can be used to provide the UI. Any other configuration to access cloud resources 205 can also be used in various implementations.

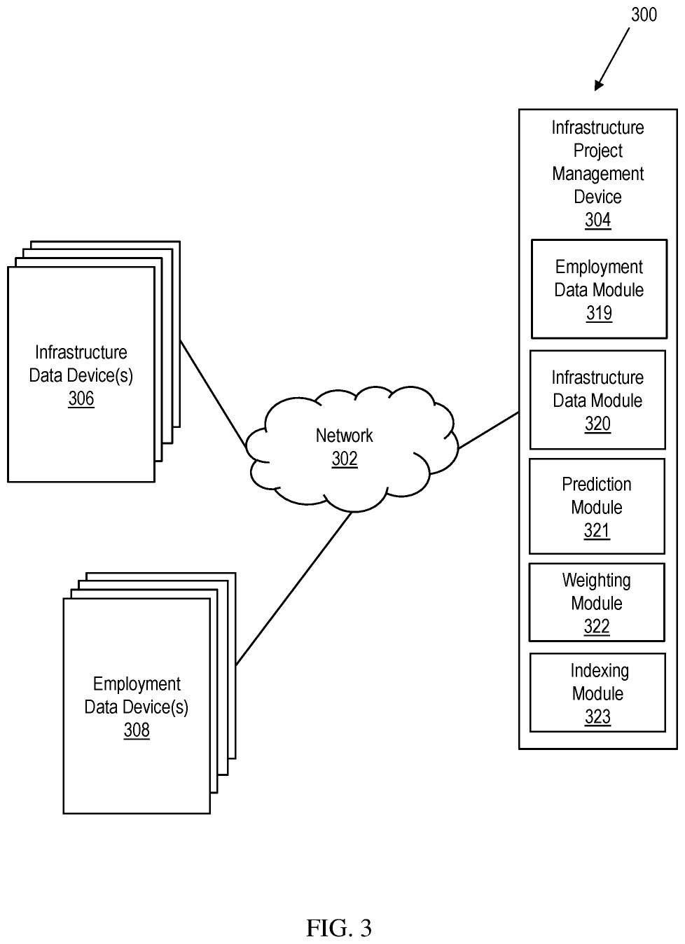

FIG. 3 shows a block diagram in accordance with aspects of the present disclosure. More specifically, FIG. 3 shows a functional block diagram of an environment 300 including a network 302 enabling communication between infrastructure project management device 304, infrastructure data device(s) 306, and payroll module or engine 308. The network 302 may be representative of the cloud infrastructure of FIG. 2.

The block diagram of infrastructure project management device 304 illustrates functionality of aspects of the present disclosure. In embodiments, the infrastructure project management device 304 comprises employment data module 319, infrastructure data module 320, prediction module 321, weighting module 322, and indexing module 323, each of which may comprise one or more program modules such as program modules 165 described with respect to FIG. 1. In embodiments, the infrastructure project management device 304 monitors infrastructure data device(s) 306 for current, planned and new infrastructure projects.

The infrastructure project management device 304 may include additional or fewer modules than those shown in FIG. 3. In embodiments, separate modules may be integrated into a single module. Additionally, or alternatively, a single module may be implemented as multiple modules. Moreover, the quantity of devices and/or networks in the environment is not limited to what is shown in FIG. 3. In practice, the environment 300 may include additional devices and/or networks; fewer devices and/or networks; different devices and/or networks; or differently arranged devices and/or networks than illustrated in FIG. 3.

In embodiments, the employment data module 319 may include employment data collected (i.e., aggregated) from payroll data received from third-party sources. The third-party sources may include governmental sources or private sources through an opt-out or opt-in process. A government source may be the social security administration, internal revenue service, unemployment administration, or other government agencies that collect information. The private source may be a payroll company such as ADP Inc. The payroll data may be collected (i.e., obtained) from payroll module or engine 308 (i.e., data sources), which is maintained by the third-party sources. In embodiments, collection of data from the payroll module or engine 308 may include any type of employment data, that would directly affect infrastructure needs, e.g., which can be used to predict and prioritize infrastructure projects for recommendation.

In further embodiments, the payroll data may exclude such personal information as social security number, name, etc.; instead, the payroll data may include employment information that would directly affect infrastructure needs. This information may payroll information such as location of employment, location of residence, location of employer, type of employment (which is indicative of needs of the employee), for example, categorized by known sources (such as indexed by the U.S. Department of State), etc. For example, the type of employment may indicate that additional or upgraded telecommunication networking infrastructure may be needed due to the nature of employment, e.g., teleworking that requires additional bandwidth, or physical infrastructure due to travel to and from work, etc. The residence and employment location may be indicative of the need for additional or upgraded power, telecommunications, water, sewage and solid waste infrastructure.

Advantageously, the employment data may be collected on a regular or real-time basis, e.g., shorter time periods of time indicative of trending data. The employment data will thus provide enhancements over current tools which rely on static/point in time data sets; that is, payroll data is collected at shorter periods of time and better represents migration of residents, shows employment resource changes, changes in economics (i.e., financial resources), changes in demographics (i.e., white/blue collar employment shifts that may be due to changes in costs of living in a location, etc.

In embodiments, the infrastructure data module 320 is configured to aggregate infrastructure data from infrastructure data device(s) 306 (i.e., data sources). In embodiments, the aggregation may include retrieval and/or receipt of the infrastructure data by the infrastructure project management device 304 from infrastructure data device(s) 306. In embodiments, the aggregation may be from private sources (e.g., commercial entities) and/or public sources (e.g., government entities). For example, the infrastructure data may be collected from government organizations such as departments of transportation, etc.

In embodiments, the aggregated infrastructure data may include different types of infrastructure data including, e.g., road infrastructure data, mass transit data, building footprint data, telecommunications data, shipping data, water supply data, waste management data, power management data, hazardous waste material management data, and/or weather data. In more specific embodiments, the infrastructure data may include data that indicates effects on infrastructure including need, use (which indicates potential need for repairs or expansion), levels of repair (e.g., simple patching, or road replacement), maintenance, last service, damage, migration, industry needs (e.g., telecommunications and/or resource needs), resources for repair and creation, etc. The infrastructure data may also include data that indicate potential infrastructure projects to meet infrastructure needs through maintenance, additions, or upgrades. For example, road infrastructure data may include age, capability (e.g., weight rating), usage (e.g., amount of traffic, repairs already made), location(s)/pathing, repairability (e.g., number of repairs, need for repairs, level of repair, costs of repair, etc.), traffic patterns, and/or type (e.g., highway, street, toll, etc.).

Telecommunication data may be collected from telecommunications companies. The telecommunications data may include communication types, connectivity availability, antenna/access points, capabilities (e.g., capacity, communication speed, etc.), usage by location, and/or known locations of need.

Water supply data, hazardous/normal waste management data, and power management data may be collected form water, waste, and power management organizations. The water supply data, waste management data, and power management data include infrastructure such as pipes, repairability, age, distribution and management sites, capacity (i.e., potential need), efficiency, usage (i.e., demand such as amount of water used, power drawn, weight of trucks, etc.), spending, employees, etc.

Mass transit data may be collected from mass transit organizations such as a department of transportation, train companies, airlines, or busing companies. The mass transit data may include age, capability (e.g., passenger capacity), usage (e.g., actual number of passengers using the mass transit), associated infrastructure requirements (e.g., parking for commuters, roads leading to mass transit sites, bridges, tunnels, etc.), location(s)/pathing, repairability (e.g., costs of repair, need for repairs, level of repairs, etc.), and/or type (e.g., bus, commuter train, light rail, subway, air travel, etc.).

Building footprint data may be collected from satellite mapping companies or may include freely available sources such as OpenStreetMap. The building footprint data may include infrastructure locations, building dimensions, building capacity, building density, and/or terrain.

Shipping data may be collected from shipping companies, postal service, and/or surveys. The shipping data may include routes travelled, shipment capabilities, commodities, shipping flows (e.g., origin/destination, value, weight, etc.), shipment methods (e.g., rail, shipping, trucks, etc.), and/or storage locations.

Weather data may be collected from weather organizations such as the national weather service. The weather data may include weather locations, weather effects (e.g., rain, ice, snow, etc.), and/or associated infrastructure damage.

Census data may be collected from the United States Census Bureau. The census data may include population by location, employment levels, districting, demographics, housing characteristics, etc.

In embodiments, the prediction module 321 is configured to use the employment data in combination with the infrastructure data to predict future infrastructure needs by geographic region. This prediction may be based on extrapolation of employment data including migration patterns and/or trends which lead to more (as population increases) or less (as population decreases) infrastructure needs, types on employment within a certain geographic region and needs of the employee based on job title, etc. In embodiments, additional examples that may affect access to resources by geographic regions may include industry employment resource capabilities and changes such as increases or decreases in employment in certain industries (e.g., construction workers), and other infrastructure projects that are required based on current or predicted access to resources (e.g., timeliness, raw material resources (e.g., location and costs), employees, financial resources, etc.). To address the need for expansion, certain access to resources such as employees in particular industries, i.e., construction workers (which can be obtained by the employment data) or the location and cost of raw materials in certain locations may also be taken into consideration.

Such changes in need may result in expansion and/or earlier maintenance/repair of certain infrastructure in a geographic region and may result in reprioritization of infrastructure projects within a particular geographic region (over other geographic regions). Some examples of expansion may include widening of roads due to trends in employees moving to a particular region via work or telecommuting (e.g., when road capacity exceeds the type of existing road needs), greater telecommunications access, e.g., expanding telecommunications infrastructure or replacing outdated technology with newer and faster technology due to population trends obtained by employment data, expansion of waste management, water treatment, or other infrastructure capabilities, etc.

In embodiments, the prediction module 321 iteratively analyzes historical and present infrastructure data against historical needs/changes/repairs to infrastructure and current needs based on, for example, employment data, to extrapolate and construct improved predictive models using machine learning. In this way, the predictive module 321 may provide predictions of infrastructure needs based on geographic regions by extrapolating trends from training data which includes payroll information (i.e., the historical sampling and resulting infrastructure changes). For example, in embodiments, the predictive module 321 may layer the infrastructure data with trending employment data and demographic data obtained from payroll data, and for a geographic region provide a prediction of infrastructure needs (hereinafter referred to as future infrastructure needs) indicating future resource needs for infrastructure changes (including repairs and expansions).

In embodiments, the future infrastructure needs may account for at least resources (already used and needed resources for a project), any costs (including labor, capital, etc.), and how many people are needed to build the infrastructure project or would utilize the particular predicted infrastructure project. Such layering of data may contribute to improved estimates of need for infrastructure based on migratory patterns, infrastructure usage changes, and infrastructure repair/expansion timelines, and how many jobs are flowing into or out of a geographic region by industry and job type.

In embodiments, the weighting module 322 is configured to provide a weighting to data, i.e., the infrastructure data and the employment data that indicates a confidence in the infrastructure requirements prediction data. For example, the weighting module 322 may have an increased confidence in population growth due to migration based on indications in payroll data. The payroll data may then be factored into determining whether there is a need to increase water demand, roads, etc. In other words, payroll increases may be a strong indicator of population increase than an increase in water usage and, hence, would be weighted more heavily. The weighting module 322 may also take into consideration the location and cost of raw materials, in addition to whether there are people in the geographic region that have the required skill set to perform the needed upgrades and/or repairs on the infrastructure. For example, if there are no employees available for the work or the raw materials are not in the needed location or are too expensive, there may be a less weighting compared to those locations which have the required workforce and/or access to the required raw materials.

In embodiments, the indexing module 323 is configured to determine an objective value placed on the infrastructure project (hereinafter referred to as an infrastructure project value) for infrastructure project completion time or project timeline and geographic region. In more specific embodiments, the infrastructure project value is determined by comparing projects in the geographic region against one another. The infrastructure project value may additionally account for other considerations such as the location and cost of resources including how much raw material there is for a project, where the raw material is located, the estimated cost to buy/ship the raw material, etc. In embodiments, the infrastructure project value may also be determined through an aggregation of all the infrastructure project requirements for all the infrastructure projects in a geographic region compared to other infrastructure project values of other geographic regions. In other words, in comparing use of resources, the infrastructure project value indicates whether investing resources in one geographic region may be more beneficial than investing resources in other geographic regions.

In a more specific embodiments, the infrastructure project value may be an observed value indicating whether the costs of one infrastructure project may efficiently meet the needs of the people of a geographic region. The infrastructure project value may be provided as a percentage of the observed value from the aggregated observed value. The observed value accounts for used resources/costs/met needs/time of completion of the infrastructure project as compared against the aggregated observed value of a total used resources/costs/met/etc. needs for all the infrastructure projects in the geographic region. In other words, the infrastructure project value indicates whether investing resources in one infrastructure project may be more beneficial than investing resources in other infrastructure projects in one or more geographic regions. In embodiments, the observed value accounts for one or more of the used resources, costs, and met needs.

For example, if an infrastructure project costs very little, has easy access to resources, and can positively affect the lives of many in a geographic region, the infrastructure project value will be high and thus indicate the infrastructure project should be selected and/or continued compared to other regions. In contrast, if an infrastructure project is expensive, does not have easy access to resources (e.g., labor and materials) and on affects a few people, the infrastructure project value will be low and thus indicate the infrastructure project should not be selected. Also, in embodiments, the met needs may also account for revenue generated by completing the infrastructure project, i.e., increased economic revenues may be realized based on increased employment, less commute times, etc. In embodiments, when an infrastructure project has already been started, the continuation of the project will weigh heavily toward selection due to already invested resources.

In embodiments, completion times may be the estimated completion date of the project, in addition to or alternatively estimated working times for the projects that overlap as well. The infrastructure project value may account for weighted or unweighted future infrastructure needs (i.e., future infrastructure needs generated from weighted infrastructure data) to predict resources required to meet infrastructure project requirements and the demand (i.e., need) for the infrastructure project. The infrastructure project value may also account for potential negative effects should an infrastructure project not be selected. For example, if a road remains unchanged, future repair costs may increase, or the road may need to be closed for a period of time which may affect the economy in the geographic region.

In embodiments, the indexing module 323 determines a regional infrastructure project value based on all infrastructure projects in a geographic region. In embodiments, the infrastructure project value is based on a percentage of the total resources needed to complete all the infrastructure projects in a geographic region over a selected time period in comparison to a total of resources for nationwide or larger geographic region infrastructure projects. The larger geographic region including the geographic region. In other words, the infrastructure project value may total all the future infrastructure needs for a geographical region as compared to all the infrastructure projects in the larger geographic region. In embodiments, the infrastructure project value of the project is based on a determination of a percentage of resources to meet the future infrastructure needs for the total infrastructure projects in the geographic region out of an aggregated infrastructure prediction data for all the infrastructure projects in the larger geographic region over a set time period (i.e., the region project requirements).

Still referring to FIG. 3, the infrastructure data device(s) 306 may comprise computing devices (e.g., the computing system 100 of FIG. 1, or elements thereof) in a networked environment. In implementations, the infrastructure data device(s) 306 comprise client devices (e.g., 210, etc.) in the cloud computing environment 200 of FIG. 2. The infrastructure data device(s) 306 may comprise one or more program modules such as data and/or program modules 165 described with respect to FIG. 1. In accordance with aspects of the invention described below, the infrastructure data device(s) 306 may store and manage access to infrastructure data. The infrastructure data device(s) 306 may store a database linking to other infrastructure data device(s) 306 or store the infrastructure data itself.

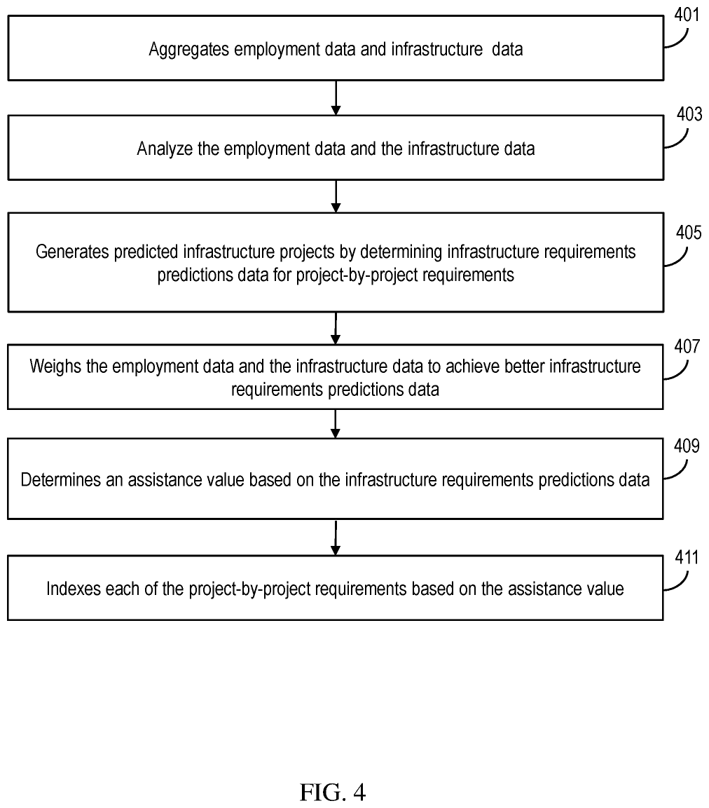

FIG. 4 depicts an exemplary flow for a process in accordance with aspects of the present disclosure. The exemplary flow can be illustrative of a system, a method, and/or a computer program product and related functionality implemented on the computing system of FIG. 1, in accordance with aspects of the present disclosure. The computer program product may include computer readable program instructions stored on computer readable storage medium (or media). The computer readable storage medium may include the one or more storage medium as described with regard to FIG. 1, e.g., non-transitory media, a tangible device, etc. The method, and/or computer program product implementing the flow of FIG. 4 can be downloaded to respective computing/processing devices, e.g., computing system of FIG. 1 as already described herein, or implemented on a cloud infrastructure as described with regard to FIG. 2. Accordingly, the processes associated with each flow of the present disclosure can be implemented by special purpose hardware-based systems that perform the specified functions or acts or carry out combinations of special purpose hardware and computer instructions.

At step 401, the infrastructure project management device 304 aggregates (i.e., collects) employment data and, optionally, infrastructure data. The aggregation of data may be from many sources or a single source, and may be from public and/or private sources. The aggregation provides the infrastructure project management device 304 with data for future analysis in predicting and indexing of infrastructure projects.

At step 403, the infrastructure project management device 304 analyzes the employment data and infrastructure data. In embodiments, the employment data and infrastructure data may be implemented with a machine learning model to predict infrastructure projects. In embodiments, the analysis uses historical employment data and infrastructure data to train the machine learning model to predict infrastructure project requirements. The historical employment data and infrastructure data is combined with time series infrastructure data to extrapolate patterns in the infrastructure data and generate infrastructure requirements prediction data.

At step 405, the infrastructure project management device 304 generates predicted infrastructure projects by determining future infrastructure needs for project-by-project requirements. The future infrastructure needs may include project-by-project requirements based on the employment data and infrastructure data. The future infrastructure needs include infrastructure needs for the geographic region and accessible resources to meet those needs. For example, as a population in a geographic region trend toward growth (as seen by employment data), a larger number of predicted infrastructure projects will be necessary to support such growth.

At step 407, the infrastructure project management device 304 weights the employment data and the infrastructure data based on a need of the geographic region. In embodiments, a weighting to each of the employment data and the infrastructure data is used to generate weighted infrastructure requirements prediction data. This weighting provides a confidence level in the prediction generated from the machine learning model. The weighting may additionally be modeled with machine learning.

At step 409, the infrastructure project management device 304 determines an infrastructure project value for a project timeline and a geographic region. This may include the geographic region based on the weighted employment data and weighted infrastructure data. The weighted employment data and weighted infrastructure data is used to generate weighted infrastructure requirements prediction data. The weighted future infrastructure needs are used to determine the infrastructure project value by providing more accurate predictions of infrastructure requirements and therefore provide more accurate information used in selecting infrastructure projects for the geographic region.

At step 411, the infrastructure project management device 304 indexes each of the project-by-project requirements based on the infrastructure project value (i.e., providing a rank to each infrastructure project based on the rest of the projects in the geographic region). The infrastructure project value may be a percentage for each of the future infrastructure needs for the predicted infrastructure project of a total of all the future infrastructure needs of all the predicted infrastructure projects in the geographic region. The indices, i.e., provides a ranking, of all the infrastructure projects based on need and capability to meet the projects with resources at hand. The need and capability including need by the population of the geographic region and employment industries relying upon the infrastructure project; cost of the infrastructure project; and timeliness of the infrastructure project. The cost including access to resources both labor and raw materials on hand versus having to import or ship such resources (i.e., quantity, quality, and location of the resources).

In embodiments, the infrastructure project management device 304 generates a report showing the indexed projects. The generated report allows a user to select projects based on either the indexing or through their own determination based on the generated report. The generated report may include reasoning for index placement for the project including potential trends based on the employment data. For example, extrapolating that more employees are telecommuting, driving to work, and/or where businesses are moving.

The generated report(s) may make use of the machine learning model by extrapolating trends in the employment data and the infrastructure data to determine indicators that predict future infrastructure projects based on need. The generated report(s) may provide explanations of why the predicted infrastructure projects are needed and/or what resources the predicted infrastructure projects would require using natural language processing. For example, if more employees in a geographic region are telecommuting, then the generated report may state a predicted infrastructure project would include sewage and/or waste management upgrades to provide the needed services to meet residential demand based on more of the population working from home.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A computer-implemented method, comprising:
aggregating, by a computer system, employment data;
analyzing, by the computer system, the employment data to generate predicted infrastructure projects; and
indexing, by the computer system, each of the predicted infrastructure projects for different geographic regions.

2. The computer-implemented method of claim 1, wherein the employment data comprises at least one of a type of employment, location of employment, and residence of an employee.

3. The computer-implemented method of claim 2, wherein the employment data includes location of an employer.

4. The computer-implemented method of claim 2, further comprising aggregating, by the computer system, infrastructure data.

5. The computer-implemented method of claim 4, wherein the infrastructure data includes at least one of a road infrastructure data, mass transit data, building footprint data, telecommunications data, shipping data, water supply data, waste management data, power management data, hazardous waste material management data, weather data, census data, or combination thereof.

6. The computer-implemented method of claim 1, further comprising predicting needs for the predicted infrastructure projects in the different geographic regions based on the employment data.

7. The computer-implemented method of claim 6, further comprising prioritizing the infrastructure data in different geographic regions based on the predicted needs for the predicted infrastructure projects and the employment data.

8. The computer-implemented method of claim 7, further comprising weighting, by the computer system, the infrastructure data to be used in selecting of the predicted infrastructure projects.

9. The computer-implemented method of claim 8, further comprising indexing, by the computer system, the predicted infrastructure projects based on the weighting.

10. The computer-implemented method of claim 8, wherein the predicted needs for the predicted infrastructure projects are further based on cost and access to resources in the geographic region.

11. The computer-implemented method of claim 10, wherein the resources in the geographic regions include people with a skill set to work on the infrastructure.

12. The computer-implemented method of claim 11, wherein the resources are determined based on the employment data.

13. A computer program product comprising one or more computer readable storage media having program instructions collectively stored on the one or more computer readable storage media, the program instructions executable to:
obtain payroll data;
obtain infrastructure data;
analyze the payroll data and the infrastructure data to determine future infrastructure needs;
index predicted infrastructure projects associated with the future infrastructure needs for different geographic regions based on at least the future infrastructure needs and the obtained payroll data; and
prioritize recommendations for the predicted infrastructure projects based on the obtained payroll data and the infrastructure data.

14. The computer program product of claim 13, wherein the indexing is based on the future infrastructure needs of each of the predicted infrastructure projects for the different geographic regions.

15. The computer program product of claim 13, wherein the infrastructure data includes at least one of a road infrastructure data, mass transit data, building footprint data, telecommunications data, shipping data, water supply data, waste management data, power management data, hazardous waste material management data, weather data, census data, or combination thereof.

16. The computer program product of claim 13, wherein the payroll data comprises at least one of a type of employment, location of employment, and residence of an employee.

17. The computer program product of claim 16, further comprising weighting components of the payroll data.

18. The computer program product of claim 17, wherein the prioritize recommendations is based on the weighting.

19. A system comprising:
a processor, a computer readable memory, one or more computer readable storage media, and program instructions collectively stored on the one or more computer readable storage media, the program instructions executable to:
collect employment data;
collect infrastructure data;
analyze the employment data and the infrastructure data to generate predicted infrastructure projects, including:
determine future infrastructure needs including project-by-project requirements for the predicted infrastructure projects, and
determine an infrastructure project value for a project timeline of a geographic region based on the future infrastructure needs, the infrastructure project value being a percentage of an aggregation of the future infrastructure needs of all the predicted infrastructure projects of the geographic region; and
index each of the predicted infrastructure projects for the geographic region based on the infrastructure project value of each of the predicted infrastructure projects of the geographic region.

20. The system of claim 19, wherein the program instructions are further executable to index region project requirements of the geographic region against other region project requirements of other geographic regions, wherein the region project requirements are based on an aggregation of each of the project-by-project requirements in the geographic region.
